(19) United States
(12) Patent Application Publication
(10) Pub. No.: US 2002/0127047 A1
(43) Pub. Date: Sep. 12, 2002

(54) Landscape table of contents and tab divider system

(76) Inventors: Russell D. Pollman, El Paso, TX (US); MaryBeth Liener Chin, Huntington Beach, CA (US); Grace Kurek, Granada Hills, CA (US)

Correspondence Address: DOUGLAS N. LARSON, ESQ., OPPENHEIMER WOLFF & DONNELLY LLP, 2029 Century Park East, Suite 3800, Los Angeles, CA, 90067, US

(21) Appl. No.: 09/809,636

(22) Filed: Mar. 12, 2001

(51) Int. Cl. B42F 13/00

(52) U.S. Cl. 402/79

(57) ABSTRACT

Title areas are preprinted on the table-of-contents sheet and oriented so that the titles are designed by the user on his personal computer and printed in the areas on his desktop printer. In addition to this sheet a set of dividers having staggered tabs are provided to the user in the retail packaging. The tabs have individual indicia (such as coloring, numbers and/or letters) corresponding to that of each of the title areas. The divider sheets when in a binder system have the tabs and their indicia running in a landscape direction from left to right. Lines on the sheet connecting the title areas with the corresponding tabs can be provided.

### BACKGROUND OF THE INVENTION

The present invention is directed to a table-of-contents and tab divider systems. An example of a commercially successful prior art system is the Ready Index-Contemporary Table of Contents-Dividers-R12138 system available from Avery Dennison Corporation of Pasadena, Calif. It is generally shown in FIGS. 1-3 at 100. Referring to FIG. 1, the system 100 includes a table-of-contents sheet 104, a set of dividers 108 having staggered tabs 112, software 116, such as on a CD-ROM, and instruction and/or title sheet 120. However, the product as currently sold does not contain a CD-ROM. Rather, it contains instructions on how to open templates that are available in MS Word, WordPerfect, AmiPro and several other word processing programs. It also has manual instructions that the user can use on his word processor if he does not want to use the templates. Each of the tabs 112 is consecutively numbered, from 1 to 8, and each one has a different background color. (The product is available in tab counts of 1-5, 1-6, 1-8, 1-10, 1-12, 1-15, A-Z, Months and 1-31.) The items are sold in a bag 122.

Similarly, the table-of-contents sheet 104 has eight (for example) predefined sectional headings 120. Each one is associated with a respective tab 112 and thus has the same color and the same number. The predefined headings 120 define elongate heading areas 124 aligned in the portrait direction on the rectangular table-of-contents sheet 104.

After the user has custom designed the headings or titles 132 to be inserted into each heading area 124, he has his printer or copier, such as the desktop printer 136 shown in FIG. 2, print the custom designed headings or titles 132 on the sheet. The printed table-of-contents sheet 104 together with the set of tab dividers 108 are then assembled in a binder system, such as the three ring binder 140 shown in FIG. 3. The desired informational pages are inserted behind the respective tab divider sheets in this divider system. As can be seen in FIG. 3, the titles 132 and the table-of-contents heading blocks 120 then line up with the respective tabs 112 of the divider sheets 108.

An example of another prior document organization system is shown in U.S. Pat. No. 5,123,676 (Donnelly et al.) (This patent and all other patents mentioned anywhere in this disclosure are hereby incorporated by reference in their entireties.)

### SUMMARY OF THE INVENTION

This prior art system described above attractively organizes the informational or other sheets in a binding system and in the proper sections as denoted by the title heads. It works very well for portrait-oriented informational sheets. However, it does not work for landscape-oriented informational sheets such as graphs and printed PowerPoint displays, because the sheets are oriented in the opposite direction of the tab indicia and the headings on the table-of-contents sheet.

Accordingly, provided herein is a table-of-contents style divider product which is specifically designed for documents that are viewed in the landscape orientation and particularly those which are eleven inches wide by 8½ inches tall. The index tab positions are arranged such that the topmost is on the left-hand side and the bottommost is on the right-hand side. The table-of-contents sheet or page itself includes preprinted blocks into which text can be written, printed or otherwise inserted. The text headings or titles refer to the contents of each section, and each block is color coded and/or numbered such that they correspond to a specific index tab.

The blocks or preprinted heading areas may be positioned in several ways to facilitate easy reading, printer formatting and enabling enough space for full section descriptions, especially with longer titles on higher-count tab sets, such as thirty-one count tab sets.

As stated above, the prior art table-of-contents style divider sets are designed to be used in a portrait direction. The blocks into which the headings for each section are written or printed are directly adjacent to the tab positions to which they refer. This arrangement works well for documents that are prepared in a portrait manner, but many documents such as spreadsheets, graphs and presentations are often prepared in a landscape orientation. As previously stated, the prior art system of FIGS. 1-3 is not suitable for organizing, storing and displaying landscape-oriented documents.

The present invention provides a product which is specifically adapted for landscape-oriented sheets, or documents, is designed with an intuitive consumer-oriented (left to right) orientation, is formatted to facilitate writing or printing into the title blocks and is easy for the reader to reference. The present system gives the document preparer or user enough space in which to format the section titles in a system that is intuitive for the reader to reference the section titles and the index tabs. The tabs are numbered or color coded in a way that preferably is intuitively left to right, whereas use of a rotated portrait table-of-contents product, such as that of FIGS. 1-3, would yield a right-to-left direction. With the title blocks arranged top to bottom, pursuant to a preferred embodiment, the user has space to type longer tab titles, especially with higher count tab sets. Additionally, the top-to-bottom orientation of the tab titles is more intuitive to the reader than a left-to-right arrangement.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is an exploded perspective view of a portrait table-of-contents sheet and divider system of the prior art.

FIG. 2 is a perspective view showing the table-of-contents sheet of the prior art system of FIG. 1 after a printing operation.

FIG. 3 is a perspective view of the prior art system, printed and assembled in a three ring binder.

FIG. 4 is an exploded perspective view of a landscape table-of-contents sheet and divider system of the present invention.

FIG. 5 is a perspective view showing the table-of-contents sheet of FIG. 4 being printed on a printer.

FIG. 6 is a perspective view of the printed sheet of FIG. 5, the tabbed dividers of FIG. 3 and landscape-oriented sheets assembled in a three-ring notebook.

FIG. 7 is a view similar to FIG. 6 showing the landscape-oriented sheets or documents.

FIG. 8 is a top plan view of a first alternative system of the present invention.

FIG. 9 shows a second alternative system.

FIG. 10 is a view similar to FIG. 6 showing the system in a spiral notebook.

FIG. 11 shows the system in a thermal binding.

FIGS. 12, 13, 14, 15 and 16 show third, fourth, fifth, sixth and seventh alternative systems.

FIG. 17 is a perspective view showing an alternative custom printed tab divider alternative that can be used in any of the systems of this invention.

### DETAILED DESCRIPTION OF THE PREFERRED EMBODIMENTS

A system of the present invention is illustrated generally at 200 in FIG. 1. It includes a set of dividers 204 having staggered tabs 208, a table-of-contents sheet 212, software 216 (such as on a CD-ROM which the user/consumer can use to custom design the titles/headings to be printed on the sheet (as discussed in detail later)), and an instruction and/or advertising sheet 220. Instead of a CD-ROM 216, the system can include instructions on how to open or create templates similar to the prior art discussed above. All of the items are provided or sold to the consumer in packaging 224 such as a bag or box.

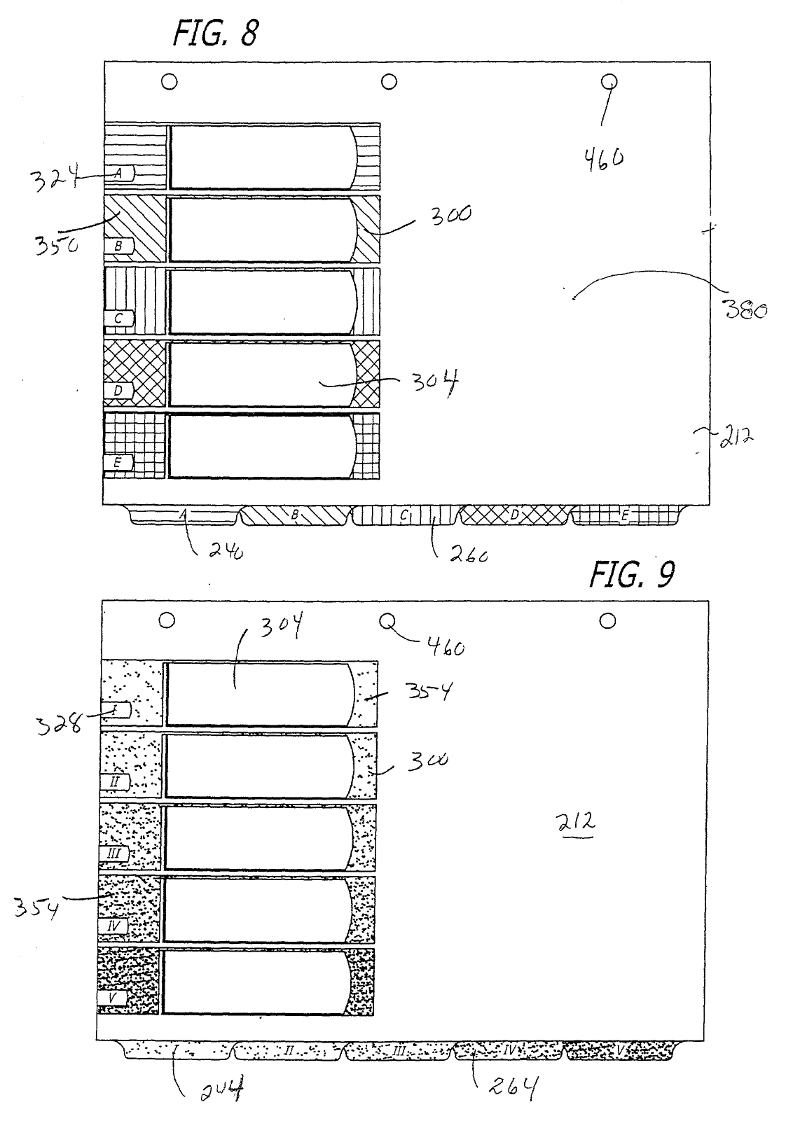

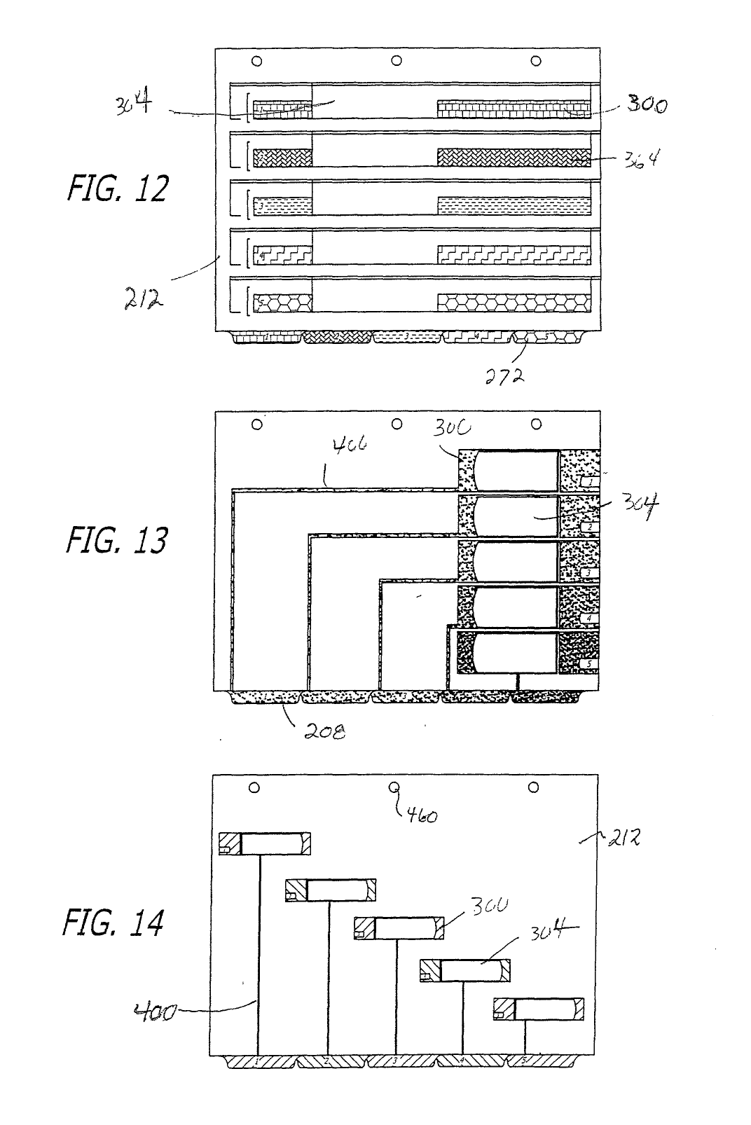

The tabs 208 of the set of dividers each have different indicia (e.g., symbols, colors, and/or patterns, etc.) 230 thereon. The indicia can be numbers 234 such as shown in most of the figures, letters 240 as shown in FIG. 8, Roman numerals 244 as shown in FIG. 9 or months 250 as shown in FIG. 12. The “indicia” in addition to or in lieu of the “symbols” mentioned in the sentence above can be different colors (such as shown by the color hatchings 260 in FIG. 8), different shading or color hews 264 (as depicted in FIG. 9), different hatchings or line patterns 268 as illustrated in FIG. 16 or different patterns 272 as shown in FIG. 12. These indicia (symbols and/or “colors”) readily distinguish one tab divider 208 from the other. They also allow the titles or headings 280 input by the consumer/user on the sheet 212 to be more readily associated by the viewer with the corresponding tab section as explained later.

The “symbols” (e.g., numbers 234, letters 240, etc.) are oriented such that with the set of dividers 204 in a landscape orientation and the tabs 208 extending downwardly, the “symbols” are preferably disposed upright. Additionally, with the divider set 204 in a stack (such as in a binder system as explained later) and the dividers oriented in the landscape orientation, the tabs 208 extend downwardly from left to right. This also can be understood from the drawing figures. This left-to-right orientation is user friendly and is opposite of the orientation if the prior art embodiment of FIG. 3 were rotated to a landscape orientation.

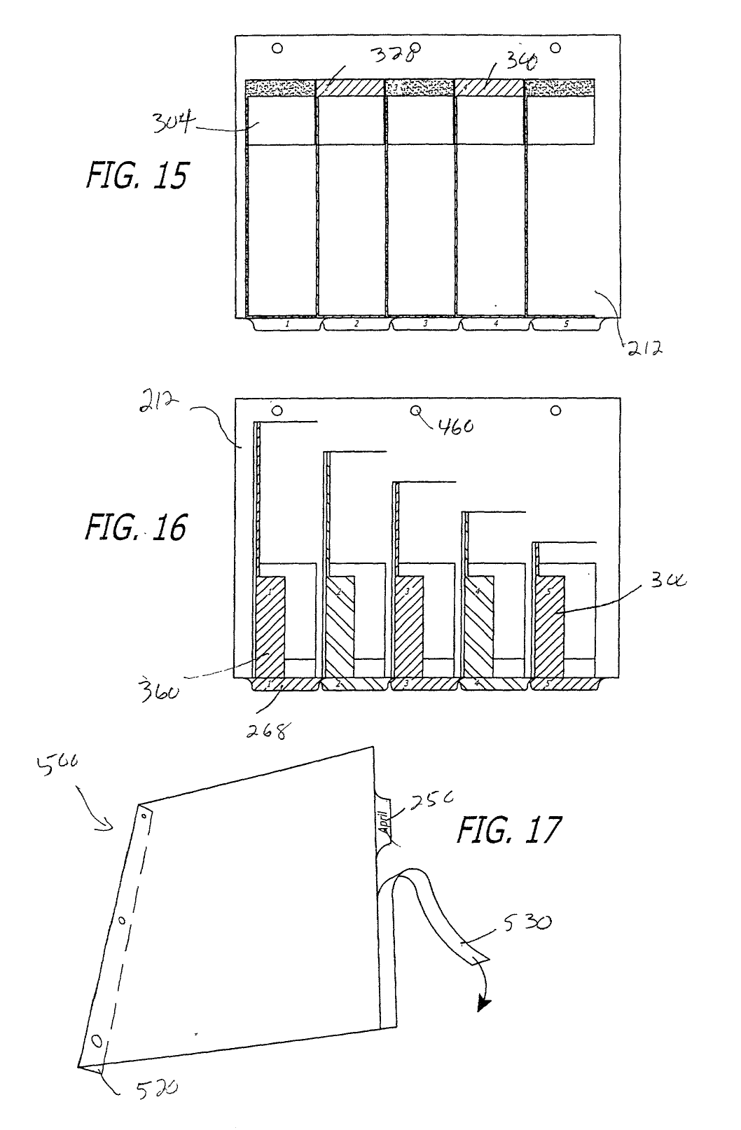

The table-of-contents sheet 212 is provided to the consumer (in the packaging 224) with preprinted heading/title areas or blocks 300, each defining a space 304 for receiving therein in a landscape orientation on the sheet a separate title or heading 280. Each of the titles or headings is associated with a corresponding tab 208. And to associate or link the titles or headings 280 with the corresponding tab 208, the blocks 300 have unique constructions. Each of the blocks 300 preferably has the same or similar indicia (“symbols” and/or “colors, etc.”) as the corresponding tab 208. As described above for the tabs 208, these symbols can include numbers 320 (FIG. 15), letters 324 (FIG. 8), Roman numerals 328 (FIG. 9), months or any other symbol as would be apparent to those skilled in the art such as years, days of the week, countries, states, hours, and so forth. And as described above for the tabs 208, the “colors” can include traditional colors 350 (FIG. 8), shading or color hews 354 (FIG. 9), cross-hatching 360 (FIG. 14), patterns 364 (FIG. 12) or other “backgrounds” as would be apparent to those skilled in the art.

A number of different arrangements of the heading/title areas 300 on the table-of-contents sheet 212 are possible. And a preferred arrangement is for them to be aligned one on top of the other along the left edge of the (longitudinally-oriented) sheet, as depicted in FIGS. 8 and 9. Alternatively, they can be “vertically” aligned on the right edge, as shown in FIG. 13, or centrally located as illustrated in FIG. 12. Another arrangement is to position them diagonally as depicted in FIG. 14. (Although FIG. 14 shows them extending from left to right, it is also within the scope of the invention to have them extend diagonally in the opposite direction.) Other arrangements (such as in an up-down-up-down positioning across the page) as would be apparent to those skilled in the art are within the scope of this invention.

When the areas 300 are grouped along the left edge as shown in FIGS. 8 and 9, a large blank area 380 is provided to the right thereof on the table-of-contents sheet 212. (Similarly, a blank area can be provided on the left when the areas are grouped on the right.) This is advantageous because the consumers can use this space to insert indicia 384. Indicia 384 can be company logos, graphics, pictures, text, etc. Indicia 384 can be inserted by printing in the consumer's printer, by adhering a label with the indicia thereon and/or by drawing it in by hand. Instructions can be provided (by the manufacturer) in the bag 224 to help the consumer add the indicia 384 to the sheet 212.

The blocks 300 are preferably aligned across the longitudinally disposed sheet as shown in FIGS. 8 and 9, for example. An alternative arrangement is to align them up and down on the longitudinally disposed sheet, as depicted in FIGS. 15 and 16. When in this “vertical” alignment, bottom portions of the blocks or heading areas can be along the bottom edge of the sheet 212 and adjacent the corresponding tab 208 when the sheet is stacked with the set of tab dividers such as in a binding system.

When the heading areas are in a horizontal arrangement they can be directly linked or “connected” to the tabs using connecting lines 400 pre-printed on the table-of-contents sheet 212. The lines 400 can be straight vertical as in FIG. 14 or right angled in FIG. 13, or other directions/shapes as would be apparent to those skilled in the art. The lines can be solid, dashed, straight, wavy, etc. The lines 400 in conjunction with the corresponding indicia help the user quickly connect or associate the heading/title in the heading areas with the corresponding tab.

A preferred method for the consumer/user to insert the titles/headings into the heading areas is to design on his personal computer using the software provided on the CD-ROM 216, for example, or preferably using new or existing word processing templates, the desired titles/headings, their fonts, etc.; and then feed the table-of-contents sheet 212 with the preprinted heading areas 280 into a printer or copier, such as shown in FIG. 5 at 406. The titles/headings 280 are thereby printed therein in the landscape orientation on the sheet. Alternatively and less desirably, the consumer/user can directly hand print or write them in. Another way to insert the titles/headings 280 is to have them printed or written on labels and the adhesive labels applied in the areas. (See U.S. Pat. No. 5,503,435 (Kline)).

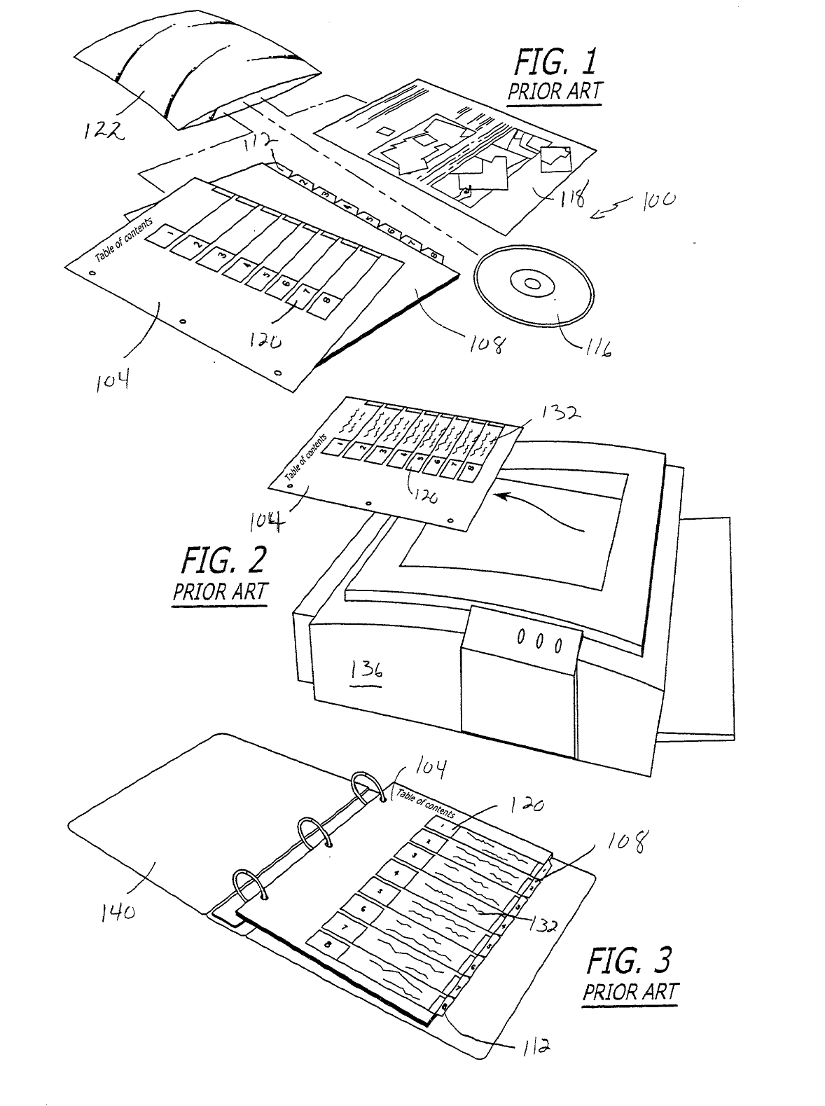

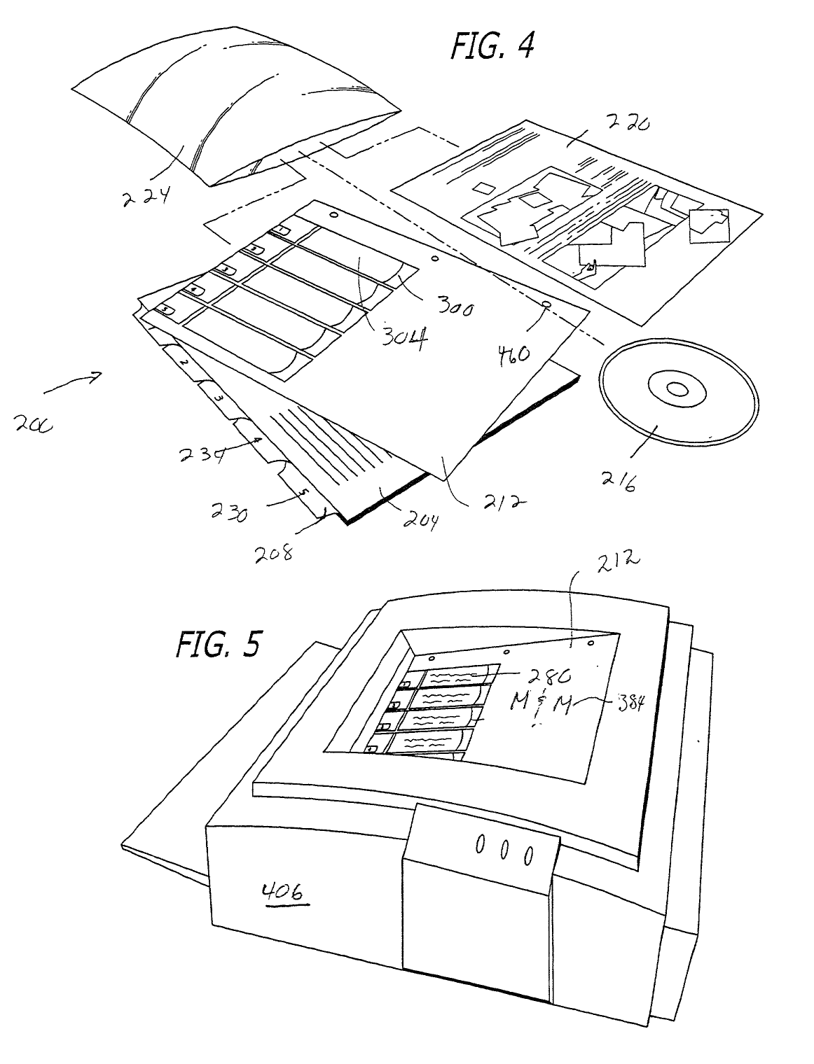

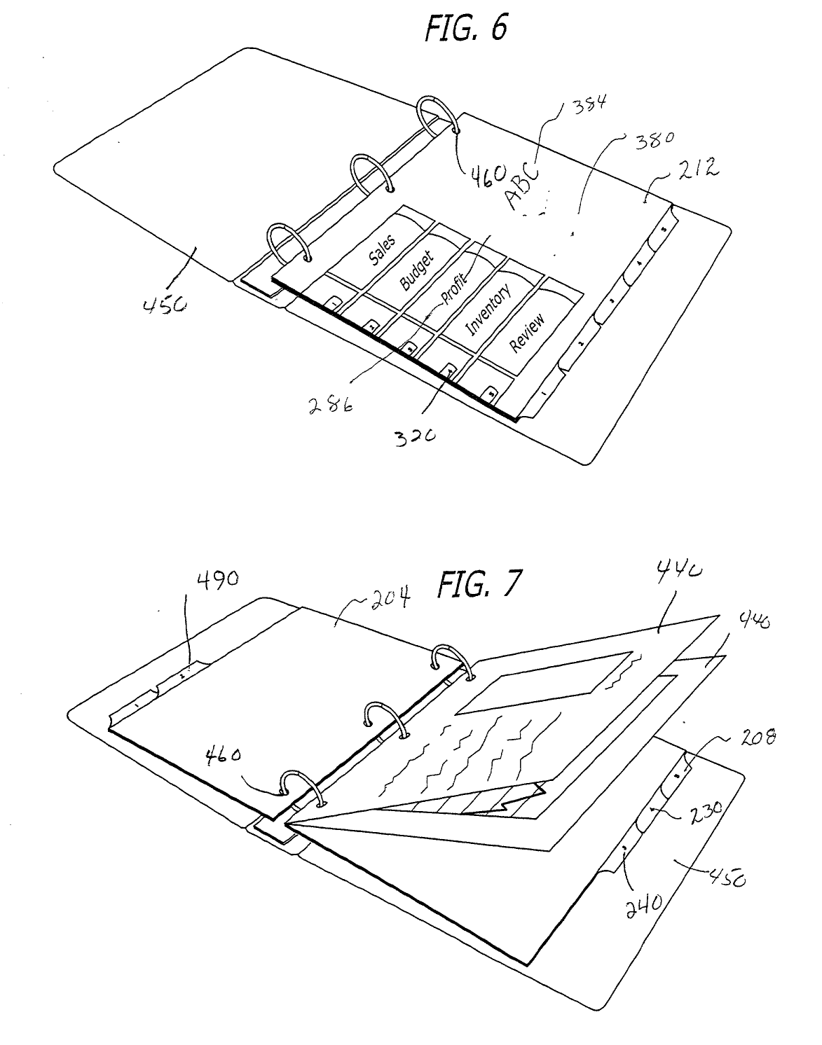

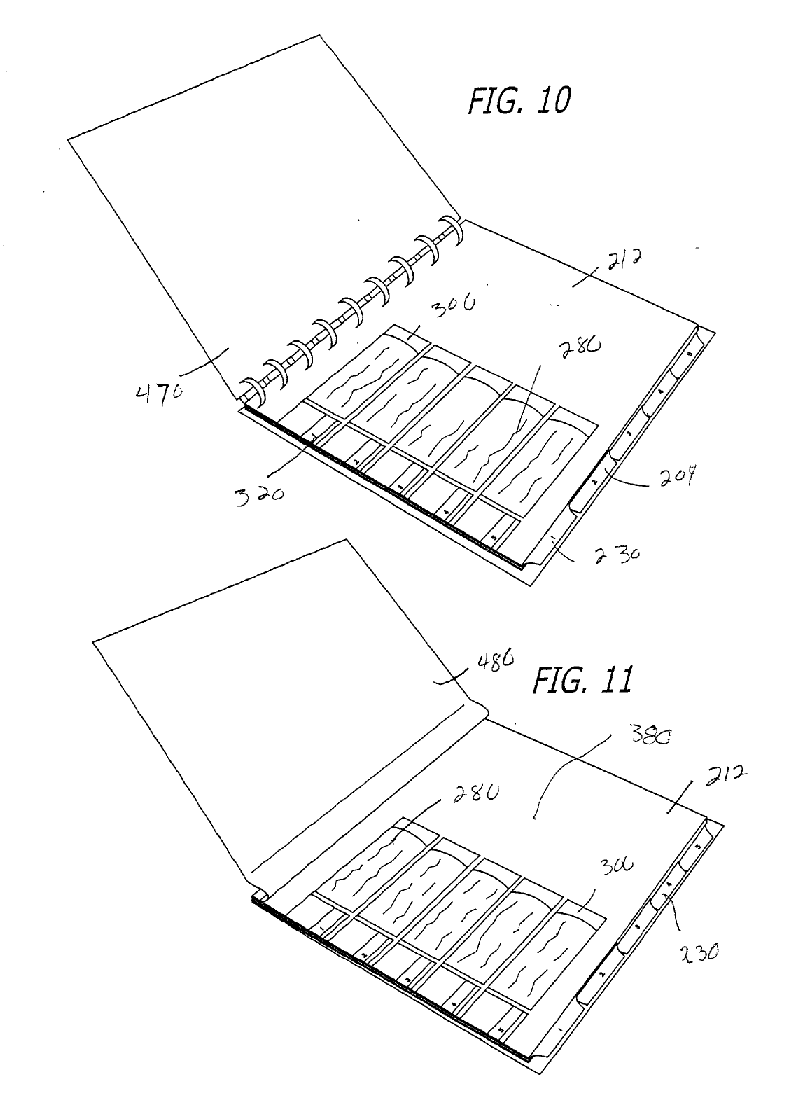

Although the blocks preferably define an entire or substantially entire perimeter of the heading/title space, it is also within the scope of the invention for only a portion thereof to be defined on the sheet 212. As discussed above, the spaces are oriented and adapted such that the headings/titles when inserted therein are oriented in the landscape direction on the table-of-contents sheet 212. This is in direct contrast to the prior art system 100 of FIGS. 1-3 wherein the title/headings are in the portrait direction. In other words, the system of the present invention is provided to fulfill a longfelt need of providing a way to organize and present in a user-friendly manner in a binding system landscape-oriented documents 440, such as graphs, PowerPoint presentations and so forth, as shown in FIG. 7. The bound system includes the table-of-contents sheet 212 (with the headings/titles inserted therein), the set of tabbed dividers 204, and the informational sheets 440, at least one of which and preferably most or all of which will be longitudinally oriented) behind the respective tabbed dividers inserted into a binding system. The binding system can be a three-ring notebook 450, as depicted in FIGS. 6 and 7. For this binding system the table-of-contents sheet, the tabbed dividers, and the informational sheets can all include ring binder holes 460. Another binding system is a spiral binder 470 such as is illustrated in FIG. 10. Any other binding systems such as thermal binding system 480 of FIG. 11 as would be apparent to those skilled in the art are included herein.

Referring again to FIG. 7, it is seen that a preferred embodiment is to print, preprint or otherwise provide the indicia or symbols 490 (such as numerals, letters, months, etc.) on the backsides of the tabs 208 oriented so that they are right side up when viewed with the binder system open. Thus, the symbols (or indicia) 490 on the backsides of the tabs 208 will be upside down as compared with the indicia 240 on the front sides of the tabs. In other words and as can be understood from FIG. 7, with the binding system open and with some of the divider sheets turned up and some turned down, the indicia 490 on the back side of the tabs 208 of the dividers turned up are in the same orientation as the indicia 240 of the tabs of the turned down dividers. More specifically, tab indicia numbers “1”, “2”, “3”, “4” and “5” (as depicted in FIG. 7) are all in proper reading orientation for a user who is reading or viewing longitudinally oriented sheet 440.

Instead of having binder holes in the table-of-contents sheet, it can be placed in a transparent pocket (not shown) which has binder holes and is separate from the table-of-contents sheet. Alternatively, the pocket can be attached to the front of the first of the tabbed dividers.

A preferred system of this invention is to supply the set of dividers 204 to the consumer (as in the packaging 224) with the symbols 230 preprinted on the tabs 208. However, it is also within the scope of the present invention to have the user/consumer insert the symbols on the tabs. And one way that he can do this conveniently is to use his desktop printer and the dividers 500 as illustrated in FIG. 17, and described in U.S. Pat. Nos. 6,004,062 (Hunter et al.), 6,099,189 (Owen et al.), 6,067,030 (Hunter et al.). So that the divider 500 with the outwardly-extending tab 208 can be fed with an 8½ inch width into a printer the binding edge 520 is folded over and releasably tacked down. And so that the tab 510 does not prevent good feeding and passing of the sheet through the printer, a peel-off strip 530 is provided adhered to the back of divider sheet along the tab edge and extending out therefrom to thereby define a straight edge. After the printing on the tab 510 and/or body sheet the binding edge 520 is unfolded and the strip 530 peeled off. See also U.S. Pat. Nos. 5,743,566 (Hunter et al.) and 5,792,297 (Hunter et al.).

As examples, the table-of-contents sheet can be a paper grade of 24# ledger stock and the divider sheets can be 32# ledger stock. For the table-of-contents sheet the printing can be offset or flexo printing using PMS colors, four color process, or hexachrome process printing. And for the divider sheets, litho printing using PMS colors can be employed.

From the foregoing detailed description, it will be evident that there are a number of changes, adaptations and modifications of the present invention that come within the province of those skilled in the art. For example, the invention can be the preprinted table-of-contents sheet by itself. As another example, the sheets of the invention can be sizes aside from 8¹2 by eleven sheets, for example, 8½ by fourteen inches or A4 sizes. Further, other combinations of the elements/features described herein are also part of this invention. It is intended that all such variations not departing from the spirit of the invention be considered as within the scope thereof.

We claim:

1. A divider system, comprising:
a set of divider sheets, each having an outwardly-extending tab;
with the sheets in a stacked landscape arrangement, the tabs being staggered, extending downwardly from the respective sheets and stacked downwardly from left to right;
different tab indicia on each of the tabs and in downwardly extending indicia orientation with the sheets in the stacked landscape arrangement;
a table-of-contents sheet having a plurality of predefined heading areas;
different heading indicia on the table-of-contents sheet, each associated with respective ones of the heading areas;
each of the heading indicia corresponding to a respective one of the tab indicia; and
the heading areas being oriented and sized such that respective headings can be selected and inserted therein by a user in a landscape orientation on the table-of-contents sheet.

2. The system of claim 1 wherein the table-of-contents sheet includes a corresponding line extending substantially from each of the heading areas to a location on a bottom edge of the table-of-contents sheet when in the landscape orientation adjacent the corresponding tab when the table-of-contents sheet and the divider sheets are assembled together in a binding system.

3. The system of claim 1 wherein each of the predefined heading areas includes a printed block perimeter or a substantial portion thereof on the table-of-contents sheet.

4. The system of claim 1 wherein the different tab indicia include tab areas of different colors and the different heading indicia include heading areas of different corresponding colors.

5. The system of claim 4 wherein the areas of different colors of the tab areas are printed on the tabs and the different colors of the heading areas are printed on the table-of-contents sheet.

6. The system of claim 4 wherein the different tab indicia and the different heading indicia also include different symbols.

7. The system of claim 6 wherein the symbols include at least one of numbers or letters.

8. The system of claim 1 wherein the different tab indicia and the different heading indicia include different symbols.

9. The system of claim 8 wherein the symbols include at least one of numbers or letters.

10. The system of claim 1 further comprising packaging enclosing the set of divider sheets and the table-of-contents sheet.

11. The system of claim 10 wherein the packaging is a box or a bag.

12. The system of claim 1 wherein the heading areas are aligned one on top of another along a left side of the table-of-contents sheet with the table-of-contents sheet in a landscape orientation.

13. The system of claim 1 wherein the heading areas are in a left to right staggered alignment on the table-of-contents sheet with the table-of-contents sheet in a landscape orientation.

14. The system of claim 1 wherein the predefined heading areas are each formed by a printed perimeter block or substantial portion thereof on the table-of-contents sheet.

15. The system of claim 1 wherein the headings are printed by a desktop printer or copier in the heading areas.

16. The system of claim 1 wherein the headings include heading indicia on labels and the labels adhered to the heading areas.

17. The system of claim 1 wherein the headings are handwritten in the heading areas.

18. The system of claim 1 further comprising means for binding the table-of-contents sheet and the divider sheets together in a stack and in a desired order.

19. The system of claim 18 wherein the desired order includes the table-of-contents sheet being on top of the divider sheets.

20. The system of claim 19 further comprising a sheet with landscape-oriented indicia thereon and positioned in the stack and behind an associated divider sheet.

21. The system of claim 18 wherein the binding means includes a ringed notebook.

22. The system of claim 18 wherein the binding means includes a spiral notebook.

23. The system of claim 18 wherein the binding means includes thermal binding.

24. The system of claim 1 further comprising sheets with landscape-oriented indicia, and a binding system for binding together in a desired order the table-of-contents sheet, the divider sheets and the sheets with landscape-oriented indicia.

25. The system of claim 24 wherein the binding system includes a ringed notebook, and the divider sheets and the table-of-contents sheet each includes ring binder holes.

26. The system of claim 1 wherein the heading areas occupy a first portion of the table-of-contents sheet and the table-of-contents sheet includes a second portion spaced from the first portion for insertion therein by a consumer of custom indicia.

27. The system of claim 26 wherein the custom indicia is at least one of printer printing, hand drawn and adhesive label.

28. The system of claim 1 wherein the tab indicia define front tab symbols on front sides of the tabs, and further comprising rear tab symbols on rear sides of the tabs and oriented upside down relative to the front tab symbols.

29. A tabbed divider system, comprising:
a set of tabbed dividers, which when aligned have staggered tabs, each of the tabs having a different indicia thereon;
a table-of-contents sheet having a plurality of predefined title areas, each aligned to receive therein table-of-contents indicia in a landscape orientation on the table-of-contents sheet;
the table-of-contents sheet having a sheet edge adjacent the tabs when the set of tabbed dividers and the table-of-contents sheet are in a binding system with sheets having landscape-oriented indicia filed behind one or more of the tabbed dividers, and the tabs extending downwardly generally the bottom of the sheet up to generally the top;
the sheet edge having sheet edge areas along the edge, each area being adjacent to a respective tab; and
lines on the table-of-contents sheet interconnecting each of the edge areas to a corresponding one of the title areas whereby the table-of-contents indicia received therein is further associated with the interconnected tab.

30. The system of claim 29 wherein the table-of-contents indicia are printed in the title areas by a printer or copier after the table-of-contents sheet has been removed from packaging.

31. The system of claim 29 further comprising a sheet with landscape-oriented indicia and wherein the binding system binds together the tabbed dividers, the table-of-contents sheet and the sheet with landscape-oriented indicia in a desired order.

32. The system of claim 29 wherein the table-of-contents indicia are printed with a desktop printer.

33. The system of claim 29 wherein the tab indicia define front tab symbols on front sides of the tabs, and further comprising rear tab symbols on rear sides of the tabs and oriented upside down relative to the front tab symbols.

34. A method of forming a landscape-oriented divider system, comprising:
providing a set of tabbed divider sheets having staggered tabs, the tabs being arranged so that when the sheets are stacked, the tabs progress along the side edge of the set from generally the bottom towards the top;
providing a table-of-contents sheet having a plurality of predefined landscape-oriented title areas; and
printing on the table-of-contents sheet in a landscape orientation table-of-contents indicia in each of the title areas, each of the indicia being associated with a different one of the tabbed divider sheets.

35. The method of claim 34 wherein the printing includes passing the table-of-contents sheet through a printer or copier.

36. The method of claim 34 further comprising before the printing, custom designing the table-of-contents indicia on a personal computer.

37. The method of claim 34 further comprising assembling the tabbed divider sheets and the table-of-contents sheet in a binder system.

38. The method of claim 37 wherein the table-of-contents sheet includes lines thereon connecting a predefined area with a corresponding tab when the tabbed divider sheets and the table-of-contents sheet are in the binder system.

39. The method of claim 37 wherein the assembling includes positioning a landscape-oriented information sheet behind a tabbed divider sheet associated therewith.

40. The method of claim 37 wherein the binder system includes a spiral notebook, a three ring binder or a thermal binding.

41. The method of claim 34 wherein the providing the set includes each of the tabs having a respective indicia thereon.

42. The method of claim 41 wherein the respective indicia are selected from the group of numbers and letters.

43. The method of claim 34 wherein each of the tabs has a color which corresponds to the color of the associated predefined title area.

44. The method of claim 34 further comprising before the printing, removing the set of tabbed dividers and the table-of-contents sheet from a package.

45. The method of claim 44 wherein the package includes a bag or a box.

46. The method of claim 34 wherein the providing of the table-of-contents sheet includes the sheet having a substantial blank area adjacent an area occupied by the areas, and further comprising inserting indicia in the blank area.

47. The method of claim 46 wherein the indicia inserting includes at least one of handwriting, desktop printing and adhesive label applying.

48. The method of claim 34 wherein the tabs have longitudinally aligned front tab symbols on front sides of the tabs and longitudinally aligned rear tab symbols on rear sides of the tabs and oriented upside down relative to the front tab symbols.

49. A sheet organizing method, comprising:
providing a set of divider sheets, each having an outwardly extending tab;
providing a table-of-contents sheet having a plurality of predefined heading areas;
inserting headings into the areas, with the headings oriented in a landscape direction on the table-of-contents sheet; and
assembling the divider sheets and the table-of-contents sheet in a binder system such that with the divider sheets in a landscape direction the tabs extend downwardly from the sheets, are in a staggered relationship and extend from left to right.

50. The method of claim 49 wherein the inserting includes passing the table-of-contents sheet through a printer or copier and thereby printing the headings in the predefined heading areas in the landscape direction.

51. The method of claim 50 further comprising before the passing, custom designing the headings on a personal computer.

52. The method of claim 49 wherein the inserting includes applying adhesive labels in the predefined heading areas.

53. The method of claim 52 further comprising printing the headings on the labels before the applying.

54. The method of claim 49 wherein the inserting includes writing the headings in the predefined heading areas.

55. The method of claim 53 wherein the tabs each include different tab indicia and the table-of-contents sheet includes different heading indicia, each corresponding to a respective one of the tab indicia and associated with a respective heading area.

56. The method of claim 55 wherein each of the tab indicia is in a desired orientation with the divider sheets in the landscape orientation.

57. The method of claim 50 further comprising before the inserting, removing the set of dividers and the table-of-contents sheet from packaging.

58. The method of claim 57 wherein the packaging includes a plastic bag.

59. The method of claim 55 wherein the tab and heading indicia include different colors.

60. The method of claim 55 wherein the tab and heading indicia include different symbols.

61. The method of claim 60 wherein the symbols include numbers or letters.

62. The method of claim 49 wherein the headings are positioned generally one above the other on the landscape-oriented table-of-contents sheet.

63. The method of claim 49 wherein the assembling includes positioning sheets with landscape-oriented indicia thereon behind the desired divider sheet.

64. The method of claim 49 wherein the binder system is a ring binder notebook.

65. The method of claim 49 wherein providing the table-of-contents sheet includes the sheet having a substantial blank area adjacent an area occupied by the title areas, and further comprising inserting indicia in the blank area.

66. The method of claim 65 wherein the indicia inserting includes at least one of handwriting, desktop printing and adherence label applying.

67. The method of claim 49 wherein the tabs have longitudinally aligned front tab symbols on front sides of the tabs and longitudinally aligned rear tab symbols on rear sides of the tabs and oriented upside down relative to the front tab symbols.
